(19) United States
(12) Patent Application Publication
(10) Pub. No.: US 2006/0100943 A1
(43) Pub. Date: May 11, 2006

(54) Method for encouraging business investment by providing abandonment value

(76) Inventor: Harold Richard Bennett, Napa, CA (US)

Correspondence Address: Robert K. Tendler, 65 Atlantic Avenue, Boston, MA, 02110, US

(21) Appl. No.: 10/981,839

(22) Filed: Nov. 5, 2004

(51) Int. Cl. G06Q 40/00

(52) U.S. Cl. 705/35

(57) ABSTRACT

A method for encouraging capital investment that includes a real option structure in which one company invests in another company and receives an exclusive field of use license plus an equity position. The equity position forms the basis of abandonment value if the option is not exercised, which offsets risk and thus encourages investment.

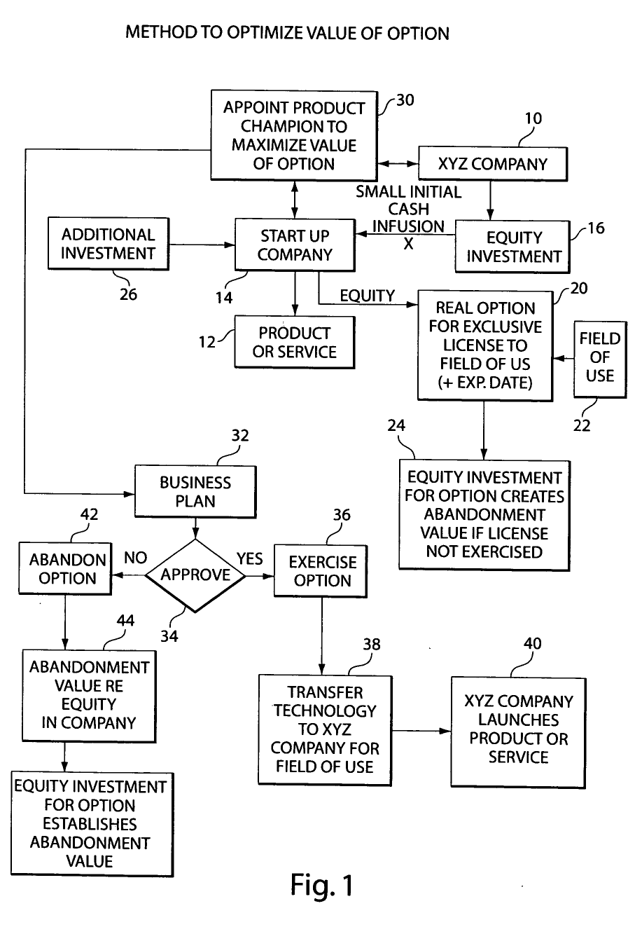

### FIELD OF THE INVENTION

This invention relates to a method for taking advantage of innovative new products that have been developed by smaller startup companies, and more particularly to a system for infusing capital into a small company by way of an option process in which the non-exercise of the option creates an abandonment value in terms of an equity position in the company granting the option.

### BACKGROUND OF THE INVENTION

Over the past numbers of years, large companies have spent over a trillion dollars in research and development in an attempt to create new products. The expenditure has resulted in many product extensions that include improvements or variations on already-existing products. However, such research and development initiatives in large companies very rarely produce genuinely new products.

As product portfolios age, many large product lines are going off patent and are becoming vulnerable to attack from low-cost producers, in particular from companies in Eastern Europe and China. The same infrastructure which allowed the large companies to expand their global reach is now being used by foreign companies that take advantage of the billions of dollars spent in creating the products.

As a result, increasingly, large companies are attempting to enhance their product portfolios with products that are protected from competition from foreign low-cost production. The major thrust in such an attempt has been to take advantage of innovative new products that have been developed by smaller startup companies. History has proven that there is perhaps no more productive way to generate innovative products than to put together a team of talented, highly motivated people focused on applying new technology.

The problem then is what are the best ways for large companies to leverage the product development efforts of these smaller companies. Historically, even though acquisition enjoys less than a 25% success rate, it is the most-employed strategy the majority of the time. However, beyond the large cash outlays required, it is oftentimes difficult to integrate the acquired company operations into those of the acquiring company.

As a result of this difficulty, rather than acquiring smaller companies, outright, large companies have started their own in-house venture capital operations. Typically, these in-house venture capital operations lose money and are not particularly effective at producing new products for the particular corporation involved.

There is therefore needed a new method to pursue the creation of new products that reduces the economic risk while maximizing the probability of creating a successful new business. As will be seen, the subject system employs a relatively new financial instrument called a real option, which is integrated into a new venture development model.

Prior to setting forth a strategy to minimize the economic risk involved in funding new technology, it will be appreciated that real options provide an alternative method of valuing investments made in real assets under considerable uncertainty. Typical business valuation employs discounted cash flow, DCF analysis, and it is based on the premise that because uncertainty increases risk, uncertain investments are less valuable than those that are more certain. This makes sense if one is investing in an uncertain product, but the question arises, what if one is only taking a look at the project before investing? Real options processes allow one to take a look at the project before investing because options provide the right but not the obligation to invest in a project. So uncertainty, which holds the potential for both good and bad outcomes by its very nature, increases the value of the options because there is the possibility of achieving a large upside gain while the only exposure to the down side is the cost of the option. It will be appreciated that the value of an option must then increase as the volatility, i.e., the uncertainty, of the underlying asset increases, whether that asset is financial or real. This leads to the concept that if a business investment is structured as an option, then uncertainty must harbor opportunity, because of the chance to capture the upside, while not being exposed to the downside. This phenomenology inspires a culture that can stimulate and sustain innovation because failure is tolerated due to its low cost, which is considered to be the price of the ticket to success.

However, while real options have been used in the past to obtain an advantage to a field of use for a large company in the product or services of a small company, the option has typically involved only the infusion of cash. If, for instance, it becomes undesirable to exercise the option, then the large company simply loses all of the option money and retains nothing. Thus, the result of abandoning the project for the large company means the loss to the large company of the money expended in obtaining the option.

### SUMMARY OF INVENTION

Rather than losing the option money that the large company has supplied to the smaller company in the case that the large company does not want to exercise the option it has, in addition to simply having an option for a license, the large company requires as a condition for the infusion of cash into the small company, an equity position. If, for instance, the small company is profitable in one field of use but is not engaged in the field of use that the large company is interested in, then even if the large company abandons its option, it nonetheless has equity in the small company, the value of which is in part established by the ongoing business of the company for which it was originally created.

Another way of understanding the subject concept is to understand that by obtaining equity in the company from which the option is to be obtained, one establishes an abandonment value such that it is desirable not to exercise the option, the large company nonetheless has an equity stake in the small company. This equity stake minimizes the loss based on the cash investment in the small company that it would incur upon failure to exercise an option. What this means is that larger companies will be encouraged to invest in product development of a smaller company because the abandonment value established by the subject option structure will offset the investment loss. Since the economic risk is tempered by the abandonment value of the equity in the smaller company, there will be a willingness to encourage the new technology through investment.

Thus, regardless of the way that the option is valued initially and the amounts of money paid for the option and the equity obtained for the investment, the subject system encourages large companies to invest in small companies because if the initial investigation of the small company indicates that the small company has value in and of itself, absent the projection of its technology into a different field of use, the large company will feel less constrained by the uncertainty of the risk of going into the technology of the small company for its own purposes, since it will reserve for itself the fall-back position of its cash infusion into the small company, resulting in an equity position.

In one embodiment of the subject invention, by way of example a large company determines that it wishes to make a small initial infusion of cash or investment into a smaller startup company in return for a real option for an exclusive license to a field of use that is suitable for the large company, plus an equity position. In most cases the option will have an expiration date, which is to be negotiated.

In order to maximize the value of the option, the company appoints a product champion that interfaces with the startup or small company to produce a business plan relative to the business of the large company. Because of the appointment of a product champion within the large company, the large company can feel secure that its investment for the option will be properly addressed through the interchange between the product champion and individuals within the smaller startup company.

The result of this interaction is a business plan, which is either approved by the large company or not. If the business plan is approved, the large company exercises its option and executes the business plan, which requires a transfer of the relevant technology from the small company to the large company so that it may be able to practice the technology in its particular field of use. The large company then launches a product or service based on the exercise of the option, whereby the large company has a better probability of success than if it simply acquired the small company, without the downside of the large investment and without the necessity of incorporating personnel from the small company into the large company.

On the other hand, if the business plan is not satisfactory to the large company, then the large company will fail to exercise the option, which constitutes an abandonment. However, in this case, the abandonment does not result in a complete loss to the large company of the option fee, but rather results in the company still retaining the equity that it has received for the small initial infusion of cash to the small or startup company.

In summary, a method for encouraging capital investment that includes a real option structure in which one company invests in another company and receives an exclusive field of use license plus an equity position. The equity position forms the basis of abandonment value if the option is not exercised, which offsets risk and thus encourages investment.

### BRIEF DESCRIPTION OF THE DRAWINGS

These and other features of the subject invention will be better understood in connection with a Detailed Description, in conjunction with the Drawings, of which:

The sole drawing FIGURE is a flow chart of the process for establishing an equity investment in a small company for an option, thus to establish an abandonment value for the large company in the case that the option is not exercised.

### DETAILED DESCRIPTION

Referring now to the sole drawing FIGURE, assuming a large company, here captioned XYZ Company 10, decides that the product or services 12 of a startup or small company 14 are of interest for a particular field of use which interests the large company, the large company enters into an equity investment 16, which results in a small initial infusion of cash into the small or startup company 14 for which the large company obtains both equity and a real option 20 for an exclusive license to a particular field of use in which the large company is interested. This field of use is indicated at 22, which may be all or a subset of the fields of use envisioned for the product or service 12 of the small company 14.

As will be seen, the structuring of the investment in the small company for the real option and equity establishes an abandonment value 24 if the option is not exercised, either within the time limit or for any other reason. It will be understood that the abandonment value is the value of the equity obtained for the small infusion of cash into the small company.

With a small initial infusion of cash into the small company, any additional investment 26 into the smaller startup company, in part due to the infusion of cash by the large company, increases the equity value that the large company holds.

In order for the large company to maximize the value of its option, the large company appoints a product champion 30 within the company to interface with the small or startup company 14 to develop a business plan 32, which is directly related to the field of use of the product or services of the small company for which the large company wishes to avail itself.

By appointing a specific individual within the large company to champion the adoption of the new technology, sufficient emphasis is given to the development of the business plan 32 that the large company can evaluate to see whether an uncertain technology that it has invested in, at least by way of an option, can be successfully used by the large company. If as illustrated at 34 business plan 32 is approved, then as illustrated at 36, the large company exercises its option. This results, as seen at 38, in the transfer of technology to the large company sufficient for it to employ the technology in the field of use indicated by the license. As illustrated by 40, upon the transfer of the technology, the large company launches the product or service with or without the assistance of the personnel of the small company.

Thus, the large company can take advantage of the newly developed technology of a smaller startup company without having to absorb its personnel, without having to be cognizant of its particular nature or structure or culture and yet minimize the down side of the company's investment in the new technology to the extent that in addition to obtaining the exclusive license mentioned above, it also has an equity stake in the company.

If on the other hand the analysis of the business plan by the large company results in a disapproval of the business plan, then as illustrated at 42 the company is said to have abandoned its option.

The result of having abandoned the option as illustrated at 44 is not a complete abandonment of the cash that was spent to obtain the option, but is rather the residual equity in the small or startup company, which was given in addition to the real option.

While there are many ways of determining the value of an option, whether it be based on the net present value or the total project value, once having arrived at a dollar value for the initial infusion of cash to the small or startup company, one has established an abandonment value to minimize the downside risk. While in the past there may have been reluctance to deduct the strategic option value cost from the project value, if the abandonment value is subtracted from the strategic option value cost, it can be seen that the value proposition moves in favor of investment.

### Examples of the Use of Abandonment Value Created by Obtaining Equity in Real Options Reasoning (ROR) and Strategic Options Reasoning (SOR)

Real and Strategic Option Reasoning has been described in an article entitled The Option Zone by Alexander B. van Putten and Ian C. MacMillan, which discusses a method of establishing real option values of uncertain projects. How the van Patten and MacMillan method is improved by establishing an abandonment value through the requirement of equity in the option agreement first starts with a discussion of Real Option Reasoning and Strategic Option Reasoning as presented in this paper.

Prior to discussing the concepts involved in this paper, by way of example, assuming that a large company establishes a venture group that has the task of finding external new technologies owned by small companies that might be commercialized by the large company, when the venture group finds an interesting technology within a stage two or stage three company that it is seeking to finance, the venture group for the large company will buy into the current round of financing at the same valuation as other investors except that the equity investment results in a right of first refusal to license the target technology for specific markets that interest the large company but that are not the primary markets for the small company. After closing the investment, the venture group then in essence sells the technology to an interested business unit within the large company, which would then commercialize the technology using the large company's substantial resources.

If, however, no license is completed, the venture group nonetheless retains its equity interest in the company.

As will be seen, by calculating the abandonment value in this manner, namely the amount used to obtain the option plus the equity, one decreases the uncertainty in the project. Assuming that the equity investment in the small company increases in value, the abandonment value of the investment increases and is therefore a deduction from the uncertainty surrounding the costs of the project.

One example of how the subject licensing technique operates to establish abandonment value and manage loss can be seen from the discussion below.

From the van Patten and MacMillan paper, as firms increasingly have to face up to dramatic increases in competitive and market uncertainty, much attention in academia is being given to using real options analysis as a way of evaluating investment opportunities. However, the reality is that CFOs are embracing the concept with some reluctance and trepidation. This is surprising because when properly managed Real Options Reasoning (ROR) prevents the creeping escalation of commitment to projects until the uncertainty surrounding the outcome has been substantially reduced, limiting the cost of failures. As a result innovation can be undertaken with the express understanding that it may result either in a successful outcome, a redirection, or complete abandonment, because the cost of failure has been limited to the pre-determined cost of the options.

Moreover, one minimizes the downside risk by retaining equity in the company as a requirement for investing in the company. Now managers are free to reach farther a field from their comfort zone without the fear of suffering a large loss and what one manager calls the “blame storming” that often occurs if their efforts fail to bear fruit. No matter what options strategy is employed, requiring an equity stake as part of the option presents the manager with much less of a downside when considering an investment.

One new option strategy which can incorporate the subject technique is called Strategic Options Reasoning (SOR).

Before going further a brief synopsis of real options is in order. Much has already been written about the best methods of valuing real options. Simply put, real options provide an alternate method of valuing investments made in real assets under considerable uncertainty. Typical business valuation employs discounted cash flow (DCF) analysis and it is based on the premise that because uncertainty increases risk, uncertain investments are less valuable than those that are more certain. This makes sense if one is investing in the uncertain project, but what if one is only taking a look at the project before investing? Real-options thinking allows one to take that look, because options provide the right but not the obligation to invest in a project. So uncertainty, which holds the potential for both good and bad outcomes by its very nature, increases the value of options because there is the possibility of achieving a large upside gain while the only exposure to the downside is the cost of the option. Following this logic further, the value of an option must then increase as the volatility, i.e., the uncertainty, of the underlying asset increases, whether that asset is financial or “real.” This leads to the key insight that if a business investment is structured as an option, then uncertainty must harbor opportunity, because of the chance to capture the upside, while not being exposed to the downside. This way of thinking inspires a culture that can stimulate and sustain innovation, because failure is tolerated due to its low cost and it is considered to be the price of a ticket to success. In fact, in an innovative company using ROR the velocity of failure will increase but the cost of those failures will decrease. The key then to option thinking is that risky investments are not only acceptable, they are desirable as long as the cost of failure is limited. What the subject invention does is even further limit the cost of failure.

Why then should CFOs be resistant to what appears to be an eminently sensible advice for managing highly uncertain investments? Aside from obtaining equity to cushion downside risks, it has been noted that there are several fundamental flaws in the current way of treating ROR. This in turn has led us to a revised way of assessing uncertain project proposals that eliminates the flaws of current ROR approaches and provides a powerful tool for CFOs and CEOs to use to analyze highly uncertain projects that have the potential for dramatically improving the profitable growth of their companies.

### An Expanded Definition of NPV

When analyzing the value of uncertain projects one can use an expanded version of net present value (NPV) called Total Project Value (TPV). Traditional DCF analysis results in a NPV calculation that relies on the decision rule that an investment with a positive NPV should be funded because it creates value above its costs. This works well enough if one is projecting future cash flows from some historical context and one is fairly certain of future trends, but when facing the uncertainties found in say new product development, NPV analysis can lead to poor decisions. The first problem is that future cash flows are unknowable because they are based on a myriad of assumptions. Therefore the odds of accurately forecasting the cash flows of a new project are slim. Secondarily defining a discount rate that properly reflects all the risks found in an innovative project is difficult to arrive at with any degree of accuracy. If one gets the discount rate wrong one may overstate, or understate, the present value of the cash flows that may lead an entity to inadvertently fund losers if the discount rate is too low or choose to abandon potential winners if one uses too high of a discount rate. But uncertainty, which is the bane of meaningful NPV calculations, is the primary driver of real option value due to the asymmetric nature of an option's payoff. As a result real options value uncertainty in a positive context, meaning that high levels of uncertainty lead to high option values, holding other factors constant. This leads us to the conclusion that the value of highly uncertain projects is composed of two components, their NPV and their strategic option value (SOV). In the beginning an innovative project will have little NPV because of the need to use a high discount rate to adjust for the uncertain nature of future cash flows. At the same time the option value of the project will most likely be high due to higher discount rates. Note that valuation components change with uncertainty.

As project development unfolds and more is learned, the outcome will become better defined because one is replacing assumptions with facts that whether favorable or unfavorable to the initial view, will reduce uncertainty. So the value of the project's NPV and Strategic Option Value will be changing as one learns more. The NPV will increase if the view of future cash flow forecasts stays the same or rises, because one should use lower discount rates to calculate their present value as uncertainty and therefore risk have been reduced as one learns more about the future. Of course the NPV could also decrease if the future cash flows appear to be less appealing than originally thought, or if the project outcome seems riskier which would call for higher discount rates. At the same time the combination of a reduction in uncertainty surrounding the project and the time of the option expiration is drawing nearer will decrease the value of the real options. If what one learns as development proceeds, increases the uncertainty surrounding the outcome, then the option could increase due to increased volatility. This might overcome the decreased time remaining until option expiration, which degrades option values. Were the development period to be extended then the option value of the project would increase. So one sees that the valuation of uncertain projects is not static as implied with the traditional NPV calculation, but it is rather a dynamic that changes with learning. One equation to capture this expanded valuation begins with the following:
TPV=NPV+SOV Eq. 1
where:
TPV=is the expanded value of NPV including the real option value of the asset
NPV=net present value of the investment
SOV=Strategic Option Value of the investment
Equation 1 further suggests that project value can be viewed as a continuum that is composed of shifting NPV and Strategic Option Values. This does not imply however, that TPV is a constant because its value will shift up or down with the future prospects of the project. This simple equation begins the process of transforming managers towards options based thinking.

Another insight contained in Equation 1 is that if the NPV of a project is either very positive or very negative, there is little reason to compute the option value that the project may offer. If the NPV is very large, the decision is easy, namely proceed with haste. Similarly if the NPV is very negative, the project should probably be abandoned unless options could be constructed that will allow managers to quickly learn a great deal about the project for very little money. It is when the NPV is modestly positive or somewhat negative that the difficult decisions need to be made. This area is called the Option Zone. The authors of the above paper have found that managers are hungry for an expanded definition of value when they find themselves in the Options Zone where traditional DCF metrics fail to provide any guidance. Rather than falling back on intuition or gut feel, which never seem to be well received by a financial audience, looking at the SOV of a project can provide a quantitative approach to thinking about what the total value of a project might be, and understanding SOV in view of the equity associated with the option is critical.

### The Option Value of Costs

Despite the appealing simplicity of Equation 1, one could think that it overstates the option value of a project because the option value increases with volatility regardless of its source. By that one means that one is uncertain about revenues or about costs, or both. The implied volatility of a project as currently calculated is derived from the uncertainty surrounding projected revenues and the uncertainty surrounding costs, because it is based on the projects projected cash flows. It is suggested that the volatility of costs, especially if it is higher than that of revenues, should not increase the option value of an uncertain project; but should instead be a deduction from the option value. The option value of costs is a somewhat artificial construct that can be computed from the range of assumption values used in building the forecast of expected future cash flows. The greater the uncertainty surrounding a project, the wider the assumption ranges which in turn leads to greater volatility estimates and higher option value.

For example, assuming that one is fairly certain that the selling price of a new blue widget will be between $12 and $14 next year. That $2 range in the expected selling price will work its way through the financial model and lead to an implied volatility that drives option value. But what if one is really uncertain about the selling price of a yellow widget, estimating the price range to be between $10 and $18? That larger $8 range in the expected selling price will increase the option value because one has increased the uncertainty surrounding the future profitability of the yellow widget should one decide to produce it. This makes sense because unless the expected market price appears to lie at the high end of the range the widget will not commercialized. This is in keeping with option-based thinking. But what if one is fairly certain of the future revenues from a project, but very uncertain about the costs surrounding the project? This could happen when planning the “slam dunk” product that everyone would want if only it could be produced at a reasonable price.

Or think of the uncertain development costs in biotech. Under current option valuation methods uncertainty has the effect of increasing the volatility of the projected returns, and therefore option value, whether or not one is uncertain about costs or revenues. But is a venture with undefined development and/or operating costs really more valuable than one that has a more certain cost structure? The answer is no and many of the CFOs agree. Highly uncertain cost structures create real risks of investment losses that should not be mitigated by the high option value they can engender. So one needs a way to understand what the net option value (NOV) of a project is. One can define this to be the option value of the revenues minus the option value of the costs, which expands Equation 1 into:

$$TPV = NPV + ( SOVr - SOVc ) = NPV + NOV \qquad Eq . 2$$

Where:

SOVr=the strategic option value of forecasted revenues of the investment.

SOVc=the strategic option value of the forecasted costs of the investment.

Here one defines costs to include the development costs, the cost of goods sold, fixed and variable costs relating to the investment under consideration.

NOV=net option value

Equation 2 holds the insight that if the option value of the costs outweighs that of the revenues, then the option value of a project would be negative and therefore reduces TPV. This is a surprising concept but it can happen if there is a great deal of uncertainty about the costs of a project, which would lead to a higher implied volatility of costs and thus to a larger option value. With this concept one can also address one of the weaknesses of adapting financial option valuation methods to real options and that is that the cost of financial options is determined at the time of purchase and that the price of an equity share cannot go below zero. In the financial world the only loss that an options investor is exposed to is the cost of the option. But in the real world losses can exceed the value of a project which makes mangers risk averse. Computing SOVc quantifies project risk and explicitly deducts it from project valuation. By contrast if one does not break out the option value of costs the uncertainty about the gross margin of a new product would increase the value of the project through the implied volatility of the cost structure. The importance of SOVc is especially relevant in the Options Zone when managers face the toughest decisions about new investments.

One example of the importance of Equation 2 involves a large industrial company that was venturing into biotech. The company had developed a new polymer as a result of millions of dollars of R&D and it held great promise as an additive to a number of consumer products. At the time project managers had already decided to spend money on safety testing to be followed by sophisticated consumer testing, all of which indicated that the polymer held considerable value. All the signals were flashing green with a positive NPV even though the company had no experience in manufacturing the polymer in commercial quantities and there was considerable discussion about that fact. Despite the uncertainty surrounding manufacturing costs it was estimated that the polymer could be produced for approximately $20 per unit, including a cushion or so it was thought.

It turned out that the manufacturing process was far more difficult than estimated and that the cost to produce the polymer would be several hundred dollars per unit, which put it outside the range of commercial viability.

Had the company used the above methodology to determine TPV things may have turned out differently. The considerable uncertainties surrounding the manufacturing process would have generated a very high SOVc, which in turn would have substantially reduced the projected TPV for the polymer. This result would have created two signals for the company. One signal was that since the SOVc was very high, the manufacturing process contained the bulk of the uncertainty surrounding the project. So the business development effort may have been reordered to go from R&D to manufacturing feasibility, then onto consumer and market testing in order to first resolve the area of primary uncertainty, that being the cost of manufacturing. The second signal resulting from the calculation of SOVc would have been a greatly reduced TPV that may have the curtailed investment in the polymer at a much earlier stage, saving millions.

One arrives at the value of SOVc by calculating the ‘call value’ of the projected ongoing operating costs associated with an uncertain project, whether it be a new or repositioned product, market test or new marketing campaign, new strategy or an acquisition, in the same way that one normally calculates the call value of projected cash flow. In essence one is calculating the call value of the costs one would avoid by not undertaking the project.

Another way to think of this is that SOVr is the value of an option to make money, while SOVc is the value of an option to spend money. One computes SOVc by listing a range of values for each of the cost assumptions. The range estimates should be wide enough so that one is 90% certain that one has captured all the possible values for each cost element, remembering that one tends towards overconfidence regarding one's ability to estimate future events, so the ranges included in the 90% confidence interval should be wider than one might think necessary. For instance, one could estimate that the cost of raw materials for the yellow widget could fall within a range of $2.75 to $4.10 per widget with a 90% confidence that the actual cost will lay within that estimate. The high and low values of the range, and all of the intermediate values as well, flow through the financial model using easy-to-use simulation software that produces a distribution of all the possible costs of our project. This cost distribution yields a proxy for the implied volatility of the costs that is used to calculate SOVc. While the concept of calculating the call value of costs is different and it may not fit with traditional financial thinking it is nonetheless valid within the realm of TPV and it finds its usefulness in guiding better strategic decision making.

This is illustrated by using a well-known example, Iridium. This was a business that intended to deliver global satellite based phone service to executives traveling internationally using $3,000 phones who were also willing to pay approximately $8 per minute for a call that could only be made while standing outside with line of sight to satellites circling the equator. It was not only an uncertain plan from the outset, but one that had a $5 billion cost structure.

Using typical option pricing models the uncertainties in the Iridium revenue model along with the cost structure would have generated enormous option value. One need only think about what Iridium's projected the future cash flows must have been to justify the $5 billion dollar investment, in order to guess at the value of an option on Iridium's potential success. But this would belie the fact that billions needed to be spent before going to market.

Had Iridium's management team used the above-described methodology the option value of those tremendous costs would have been deducted from the TPV of Iridium, leading to a greatly reduced valuation and perhaps to an early rejection of the investment, rather than to its subsequent liquidation that realized less than $70 million. If one were to make the vastly simplifying assumption that the $5 billion of costs was spent in two years and assuming a cost of capital of 10%, then the discounted cost of the Iridium system would be $4.13 billion.

Assuming that because Iridium involved launching numerous satellites into orbit that there was a great deal of uncertainty regarding the final costs of the project, this yields a volatility estimate of 60%, approximately twice the volatility of the S&P 500. To get a sense of how an uncertain cost structure can affect project value one can model how Iridium's costs could unfold over the two years. Using the present value of the expected costs of $4.13 billion as a starting point; project costs could unfold with a 60% volatility estimate, to lie in a range of $1.24 billion if all the costs come in at the low end of estimates, to $5.15 billion if all costs come in at the high end of expectations. Obviously this enormous range would have immense implications for the future profitability of the Iridium venture.

But to really understand what the uncertain cost structure means to the venture, one needs to compute SOVc. One can easily do that using the Black Scholes option pricing model, which yields a SOVc value of approximately $1.3 billion. So management would have had to deduct that figure from their calculation of the Iridium's projected value, which may have deterred them from proceeding in the first place.

### Abandonment Value

There is however, a greater relevance to deducting SOVc from project value because it forces managers to focus on reducing the uncertainty surrounding the costs of a new project early on in order to increase TPV. Uncertainties surrounding costs are usually easier to get a handle on because they are to some extent defined by the managers involved with a project. So if senior management were to set a goal that a project must have a TPV of X at some future time in order to justify a second round of investment, the easiest way for project managers to meet that goal is to tightly define the costs of the project. This focus serves a company well by preventing sunk costs from building up in advance of supporting data.

This is a key skill to creating an innovative culture that embraces the notion that success is built on the back of many failures, as long as the cost of failure is kept within predetermined bounds and it is recognized early; allowing resources to be redirected elsewhere. Thinking about the cost variance of a project should drive managers to look for ways to mitigate that uncertainty by devising exit strategies in advance of investment. Pre-planned exit strategies create abandonment value that function in the same way as a put option functions in the financial world: a hedge against lower values in the future. So the idea is for project managers to create abandonment value in advance of making an investment in a project in order to mitigate the costs of failure.

### Creation of Abandonment Value

In the subject invention, abandonment value is measured by the equity stake required for the real options.

Note that such abandonment value reduces the uncertainty of a project's cost structure and one therefore deducts it from SOVc. This key concept expands Equation 2 to become the following:
TPV=NPV+SOVr−(SOVc−Abandonment Value) Eq. 3
Looking at Equation 3 one sees that as abandonment value increases it decreases SOVc, which in turn increases TPV (holding NPV and the option value of revenues constant). This motivates managers who are championing investments with uncertain outcomes to lock in abandonment value early as the fastest way to raise the value of TPV.

In accordance with the subject invention, the most certain way of calculating abandonment value is to take it as the value of the equity in the company required for the option.

Abandonment value can be created in a number of ways. First think about what value the early investments in a project may have to another company or to another business unit within your company. In large multinationals what doesn't work for one division may prove to be a departure point for another division elsewhere in the organization. The salvage value can be created through internal transfer payments in large companies between business units that set a price for the development work that was done on a project before it was discontinued. Or assets such as the IP that was developed can be sold for cash or the equity of other companies.

Creating abandonment value is especially important in businesses that require large scale and large fixed costs to win. In Iridium's case perhaps management could not have avoided the huge sunk costs of launching a system of satellites before knowing how the market would evolve, but had they been forced to focus on reducing SOVc they might have; a) seen that the idea was fundamentally flawed because SOVc was enormous; or b) designed the satellites to provide greater functionality beyond Iridium's proprietary needs so that they might have been of use to the communications industry that was hungry for satellite bandwidth; c) launched the system using a combination of land based and satellite relays to hold down costs until the market uncertainty was resolved. Devising ways to reduce SOVc in advance of making an investment in a project is an extremely important aspect of using ROR as it limits the downside cost of a project and this exercise should be required before funding takes place. Furthermore even if abandonment value cannot be created in advance of investment the exercise will discipline managers to focus on cost containment.

One venture capital group, Ventures, has implicitly been using the above expanded concept of total project value to structure its deals. Ventures has the task of finding external new technologies, owned by small companies, that might be commercialized by a business unit. When Ventures finds an interesting technology within a stage 1I or stage III company (Company A) that is seeking financing, Ventures will buy into the current round of financing at the same valuation as other investors, except that Ventures also acquires the right of first refusal to license the target technology for specific markets that interest the company to which Ventures is allied, i.e., Company XYZ, but which are not the primary markets for Company A. After closing the investment, which is typically in the $1 million range, Ventures then “sells” the technology to an interested XYZ business unit that would then commercialize the technology using XYZ substantial resources. If no license agreement is completed with Company A, Ventures retains its equity interest in the company, which may or may not have liquidity in the future.

By using the concept of TPV, Ventures was able to refine its deal structure by explicitly analyzing each of the value elements inherent to uncertain investments. Through its deal structure Ventures has used all the elements of Equation 3; TPV=NPV+SOVᵣₑᵥₑₙᵤₑ−(SOV_{costs}−Abandonment Value). When Ventures is first introduced to a new investment, it looks at Company A's projections as the basis for an NPV calculation. But these projections do not factor in the benefits of being associated with a Fortune. 100 firm, so they underestimate the value of the technology as Ventures sees it. So the next step in the Ventures analysis is to work with interested business units within XYZ that could commercialize the technology to generate more complete projections. This analysis yields the option value of the investment, which is our SOVᵣₑᵥₑₙᵤₑ. The next term in the equation is SOV_{costs} that is comprised of the costs that must be incurred by XYZ in order to commercialize the technology, the ongoing cost of production and the uncertainty surrounding the final license terms with Company A that are yet to be negotiated. Finally the equity interest in Company A that was purchased for $1 million or so will be owned by Ventures whether or not a XYZ business unit licenses the technology. So this equity investment in Company A, which should increase value, is considered to be the Abandonment Value of the investment and it is therefore a deduction from the uncertainty surrounding the costs of the project. As can be seen, Ventures has used abandonment value in terms of the equity obtained in the option negotiations to mitigate risk in selecting and valuing the new technology.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for encouraging business investment in a first entity, comprising the steps of, comprising the step of:
negotiating an option for exclusive field of use license between the first entity and a second entity in which the second entity obtains an option for the exclusive and equity in the first entity in exchange for a license fee to the first entity that constitutes a cash infusion to the first entity, the non-exercise of the option by the second entity resulting in an abandonment value equal to the equity in the first entity, whereby the cost of the option is offset by the abandonment value;

2. The method of claim 1, wherein the option is time limited.

3. The method of claim 1, wherein the field of use is one not covered by the business of the first entity.

4. The method of claim 1, wherein the field of use is in the business of the second entity.

5. The method of 1, and further including the steps of the second entity appointing a product champion to interface with the first entity to maximize the value of the equity transferred to the second entity.

6. The method of claim 5, and further including the step of having the product champion develop a business plan centered around the field of use of the option.

7. The method of claim 6, wherein the business plan is presented to the second entity to aid in determining whether or not the second entity will exercise the option.

8. A method for reducing the downside risk in a first entity adopting technology of a second entity, comprising the step of:
providing an option agreement for an exclusive field of use license in favor of the first entity in a field of use not practiced by the second entity, consideration for the license fee for the license including an equity position in the second entity held by the first entity, non-exercise of the option by the first entity creating an abandonment value equal to the equity position that is offset against the option fee, whereby the downside risk of investing in the option is minimized by the abandonment value, thus to encourage adoption of the technology of the second entity.

9. The method of claim 8, wherein the option includes a period of time in which the option is exercisable is limited.

10. The method of claim 8, wherein the field of use does not cover activities of the second entity.

11. A method for providing a calculation of abandonment value in a real option scenario, comprising the steps of:
providing an option for an exclusive field of use license from a first entity in favor of a second entity in which consideration for the option is an up-front fee to the first entity and in which the second entity receives an equity position in the first entity; and
calculating the cost of the option by offsetting any cost by an abandonment value equal to the equity position.
